(19) United States
(12) Patent Application Publication
(10) Pub. No.: US 2005/0089334 A1
(43) Pub. Date: Apr. 28, 2005

(54) Protocol independent managed optical system

(76) Inventors: Zvi Regev, West Hills, CA (US); Todd Rope, Pasadena, CA (US)

Correspondence Address: GARY L. SHAFFER, 901 BANKS PLACE, ALEXANDRIA, VA, 22312, US

(21) Appl. No.: 10/956,366

(22) Filed: Oct. 4, 2004

Related U.S. Application Data
(60) Provisional application No. 60/507,965, filed on Oct. 3, 2003.

(51) Int. Cl. H04B 10/00

(52) U.S. Cl. 398/139

(57) ABSTRACT

Methods and devices for effecting the protocol-independent transmission of data and other communications over fiber-optic interfaces are provided. The present invention includes devices and methods for providing a special communication channel for management, by way of an optical fiber interface, while co-operating with the normal high-speed data-carrying channel, while over the same fiber, and using the same optical wavelength. Thus the management and control of optical interfaces across the fiber-optic medium can be provided without any additional connection, and without interfering with the data signal, such that information can reliably be passed back and forth between the optical transceivers at either end of the fiber.

### RELATED APPLICATIONS

The present application claims priority to U.S. Provisional Application No. 60/507,965, filed Oct. 3, 2003. The cited Application is hereby incorporated by reference in its entirety.

### FIELD OF THE INVENTION

This invention deals with management of very high-speed fiber-optic communications systems, and in particular with the ability to manage or control the parameters of physical transport medium, and components of these systems.

### BACKGROUND OF THE INVENTION

Data communications systems commonly use fiber optic communication links to interconnect between the switches and routers, which control the flow of data in the communication networks. Many independent standards and protocols are used in high-speed communication, each with its own specific requirements and specifications. Management of the networks is an integral part of every communication standard or protocol, intended to guarantee the quality of service, and the integrity of data transmitted over the networks. Several of these protocols apply methods of passing management information between the protocol entities on either side of the link, a practice sometimes referred to as “Layer 1 management.” However, until the present invention there was no protocol-independent method of passing this information between the endpoints, and there is no method of passing information about the status and control of the optical system itself.

A Multi-Source Agreement (MSA) is an agreement between several interested parties to adopt and use a particular protocol, standard, or design. One such MSA specifies a plug-in optical transceiver interface operating at data rate of one Gigabit per second, called GBIC (Gigabit Interface Controller). The GBIC MSA defines the physical and electrical properties of the Gigabit transceiver interface. The GBIC MSA also defines a serial electrical interface, which provides access to a non-volatile memory, which stores information about the transceiver module. Data stored in the non-volatile memory include identification information of the transceiver, its manufacturer, and the transceiver's properties and capabilities. The serial interface defined by the GBIC MSA, uses a 2-wire serial communication protocol, wherein one wire is used for bi-directional transfer of data, and wherein the other wire is used to supply a clock for the serial interface. Another MSA example is the one for a small-form plug-in (SFP) optical interface operating at speeds up to 2.5 Gbps, commonly used for communication protocols known as SONET, Ethernet, and Fiber-Channel. The SFP MSA specifies a serial communications interface identical to the one specified by the GBIC MSA.

As part of the MSA specifications, the serial communications interface provides access to two management features of the optical transceiver. The first management feature is access to the device specifications such as transmitter wavelength, and the second management feature is the access to device status information, including temperature and certain voltages. The MSA documents also describe the management system and communications protocol for both SFP and GBIC types of transceivers, and define the specific addresses within the non-volatile memory in which certain management related is to be stored. The MSA protocol defines access to management related information using electrical wiring only, and does not deal with management access using the optical interface. Thus, the management as it is specified cannot access the transceiver on the remote side of the fiber optic link and check its properties and status. FIG. 1 shows a typical SFP or GBIC optical transceiver.

Generally data is random in nature and electrical properties such as frequency spectrum are unpredictable. To transfer data through networks, and to make the performance of such networks predictable, the randomness of the data carried over the network must be limited. This is achieved by encoding the data by codes that insert periodicity and bandwidth limiting properties into the transmitted data. In typical encoding processes the data is divided into bytes of 8 bits, or nibbles of 4 bits, and wherein each nibble is replaced by a specific code comprised of 5 bits, and wherein bytes are replaced by specific code of 10 bit each. The uniqueness of the replacing codes is that the number of “zeros” in the new codes equals the number of “ones”. Also, the number of consecutive bits having the same sign, one or zero, is limited, otherwise known as limited run-length. In a code known as 8B10B the run-length is 5, and therefore the maximum number of consecutive ones or zeros is limited to 5. This encoding method adds 25% to the data carried on the network, but provides the encoded data with two very important properties. First, the average DC voltage of any significant length of data stream equals half the peak to peak voltage swing of the data, and thus may be transferred through capacitive or inductive coupling. Second, its frequency spectral bandwidth is limited because the upper frequency-limit is defined by the duration of a single bit, and the lower frequency limit is defined by the number of consecutive bits of the same sign.

As an example, for data transmitted at a rate of 1 Gigabit per second, after the encoding, the data rate is increased to 1.25 GHz, and is clocked at a clock rate of 1.25 GHz. The duration of a single bit is 0.8 nanoseconds, and the duration of the longest span of 5 consecutive bits of the same sign is therefore 4.0 nanoseconds. Therefore, this type of data transmission occupies a frequency spectrum of 250 MHz to 1.25 Ghz, or a total bandwidth of ₁ GHz centered around 750 MHz, as shown in FIG. 2.

The level of optical power transmitted over an optical fiber, is defined by the distance it has to travel, and the sensitivity of the receiver at the remote end of the fiber. The sensitivity of the receiver is defined by the noise level at the input to the receiver. To guarantee a desired bit error rate in the data transferred over the fiber optic link, a certain ratio is required between the power of the noise, and the power of the signal at the input to the receiver. Typically the estimates for noise power are very conservative, and the amount of signal power received by receivers is much higher than the required minimum for the desired signal to noise power ratio.

The present invention includes devices and methods for providing a special communication channel for management, by way of an optical fiber interface, while co-operating with the normal high-speed data-carrying channel, and being over the same fiber, and using the same optical wavelength.

This invention is based on the following observations or assertions: First, the data used by management is quasi-static, and thus requires a very limited frequency bandwidth to be transferred over a communication link. Second, the power of the noise is directly proportional to the frequency bandwidth of the system over which it is measured. The second assertion means that for the transfer of data at a small frequency bandwidth, the noise power is low, and therefore the magnitude of the required signal power is low as well. If for example the bandwidth for data on a communication link is 1 GHz, and the frequency bandwidth required for management is 1 MHz, the noise power in the management cannel is 1000 times smaller than that of the data channel, and therefore a management signal power 1000 times smaller than the data signal power will provide the same bit error rate as for the data.

Laser diode transmitters are typically operated by driving currents of variable magnitude through the laser diode, as shown in FIG. 3. A typical laser diode transmitter is driven by two currents, generated by two independent current sources. A bias current source is controlled by a control circuit, which sets the average optical power output from the transmitter, and is quasi-static in nature. The bias current varies only when the average optical output power generated by the laser diode changes due to changes in the environment, or aging of the laser diode. A data driven current source generates a current that varies as the data at the input to the transmitter varies, and thus modulating the laser, and causing it to generate an optical power which varies in response to variations in the data. The magnitude of changes in the modulation current, determines the modulation depth, or the ratio between the maximum output of optical power, and the minimum output of optical power. Typically, the state of minimum optical output power is considered the “zero” state, and the state of maximum optical output power is termed as the state of “one”.

In this invention, a third current source is added the transmitter to add a management communication path through the optical fiber interface, as shown in FIG. 4. The magnitude of the current variations in the management current source is significantly smaller than the current variations generated by the data modulation current source, typically an order or even two orders of magnitude smaller. As a result, the management information modulation is added like a small ripple on top of the data modulation of the optical output power, as shown in FIG. 6.

The frequency bandwidth allocated for the management is very limited, typically three orders of magnitude lower than the frequency bandwidth allocated and used by the data transmitted over the fiber optic communication link. FIG. 5, shows the frequency bandwidth and optical power levels allocated to the data and the management signals.

A prior art fiber-optic receiver is comprised of a photodiode, a transimpedance amplifier, and a limiting post-amplifier, as shown in FIG. 7. The fiber-optic receiver in this invention is modified, as shown in FIG. 8, wherein the electrical signals at the output of the transimpedance amplifier, are applied to two filters. A highpass filter passes all the data, which is at a very high frequency, to the limiting post-amplifier. The lowpass filter block all the data, as it is high frequency, but passes the management signals, which are at a very low frequency. The output signal of the limiting amplifier follows the variations of the signal at the input to the amplifier as long as the magnitude of largest signal at the input to the amplifier is smaller than the limiting level signal for the amplifier. The limiting level of the amplifier depends on the gain of the amplifier, and for the typical limiting amplifier the gain is high, and the limiting level is low. As a signal at the input to the limiting amplifier reaches above the limiting level of the amplifier, the output of the amplifier does not follow the input signal any longer. Thus, the limiting amplifier “discards” all the variations in the signals at the input amplifier, which are above its limiting level. As a results, the management signals which “rides” on top of the high-speed data, as shown in FIG. 9, is rejected by the limiting amplifier, and does not affect its output, which is shown in FIG. 10.

The low frequency signals coming out of the lowpass filter are combined of the DC average of the high-speed signal at the input to the filter, and the low frequency management data “riding” over it as shown in FIG. 11. To discriminate between the static DC average, and the low frequency, but variable, management data signal, a second lowpass filter comprised of the resistor R1, and the capacitor C1, is used. The time constant r=R1C1, is selected such that τ>>tₘₐₓ, wherein tₘₐₓ is the duration of the longest run of consecutive bits of the same sign. The second lowpass filter rejects all the components of the management data signals, and signal coming out of f the second lowpass filter is the DC average only. The differential amplifier which follows the second lowpaqss filter, amplifies the difference between the DC average, and the management data signals, and outputs the management data only, as shown in FIG. 12.

FIG. 13, shows a fiber-optic communication link, modified to carry management data from one end of the fiber, to its other end, and back, thus allowing the management on one end to monitor, and control the transceiver on the other end. These monitoring and control functions include, but are not limited to, Optical transmission wavelength, transceiver manufacturer and ID number, transmitter laser temperature, transmitted optical power, received optical power, requests to increase or decrease the level of transmitted optical power, request for a “loop-back” of signals transmitted, and requests to change transmitters or receivers in communication links with redundant paths.

A special case of fiber-optic installation is that of a single point to multi-point fiber-optic interface, shown in FIG. 15. This type of interface is typically used inside offices, and in apartment buildings, where a single pair of fiber-optic cables enters the building or the office. The distribution and interface to all the clients is done via fiber-optic cables, without resorting to any electrical connection between the main transceiver and any client. In what is termed as “down stream” in an interface of this kind, the transmitter in the main transceiver transmits data, via a single fiber which, is split to n fibers in order distribute the transmitted data to the receivers in all of the transceivers. All the receivers therefore receive identical copies of the same data. Since data on networks typically includes a header specifying the destination of a every packet, only the client to whom a packet was addressed, continues to process the received packet, while other clients which are not addressed, discard the packet.

Sending packets in the opposite direction, also known as “up stream”, is more complicated. In the single point to multi-point fiber-optic interface, fiber connecting to the optical transmitters in all the transceivers but the main transceiver, are fused together to form a single fiber connecting to the receiver of the main transceiver. Since all the transmitters transmit their optical power into a single fiber that connects to the main receiver, and wherein all the transmitters transmit on the same optical wavelength, only one transmitter is allowed to transmit at any given time. In a typical installation of a single point to multi-point interface, the main transceiver, controls which client transmitter is allowed at any moment. In one standard protocol, the main transceiver sends special management packets addressed to one transceiver at a time, informing it of the length of time it is allowed to transmit back to the main transceiver. When that time is over, the main transmitter sends a special packet to another transceiver allowing it to transmit over a predefined time, and so on. This method is very inefficient and greatly reduces the usable “up stream” bandwidth available to any client. This method also requires the involvement of the client system extraneous to the transceiver to decipher the transmission control packets, and control the duration of any transmission.

Using the management transmission method described in this invention, and shown in FIG. 16, each transceiver is modified to handle management transmission and reception simultaneously, and over the same optical wavelength, as the normal data transmissions. Management messages are transmitted simultaneously with any data transmission, riding on top of the data transmitted. When the main transmitter transmits “down stream”, data and management messages are distributed simultaneously to all the receivers. The management messages “down stream”, are addressed to a particular client, the same way normal data messages are. The extraction of the management data, and its deciphering is executed within the confines of the transceiver, by the management controller, and does not require the involvement of any extraneous devices. “Up stream” management messages are generated by the management controller inside a transceiver, are sent by the transceiver during the time they are allowed to transmit, simultaneously with the transmission of regular data.

### DESCRIPTION OF THE FIGURES

FIG. 1, Shows a block diagram of a typical GBIC or SFP Optical Transceiver Module.

FIG. 2, shows the frequency spectrum occupied by a Gigabit data stream.

FIG. 3, Shows the block diagram of a typical laser transmitter.

FIG. 4, Shows an embodiment of a laser transmitter modified to include management signals transmission.

FIG. 5, shows the frequency bandwidth, and power allocated for data and management in this invention.

FIG. 6, Shows an example of the combination of data and management signals modulation of the optical output power.

FIG. 7, shows a typical fiber-optic receiver.

FIG. 8, shows an embodiment of a fiber-optic receiver modified to receive and output management data.

FIG. 9, shows the range of signals amplitudes processed by the limiting amplifier.

FIG. 10, shows the data signals at the output of the limiting amplifier.

FIG. 11, shows the signals at the inputs to the differential amplifier.

FIG. 12, shows the signal at the output of the differential amplifier.

FIG. 13, shows an embodiment of a fiber-optic transceiver modified to transmit and receive management data via the optical fiber.

FIG. 14, shows an embodiment of a fiber-optic communication link with management signals transmitted via the optical fiber.

FIG. 15, shows an alternative method of extracting the low frequency management signals.

FIG. 16, shows a case of a single point to multi-points fiber-optic interface.

FIG. 17, shows the case of a single point to multi-points fiber-optic interface with management data and commands passing via the optical fibers.

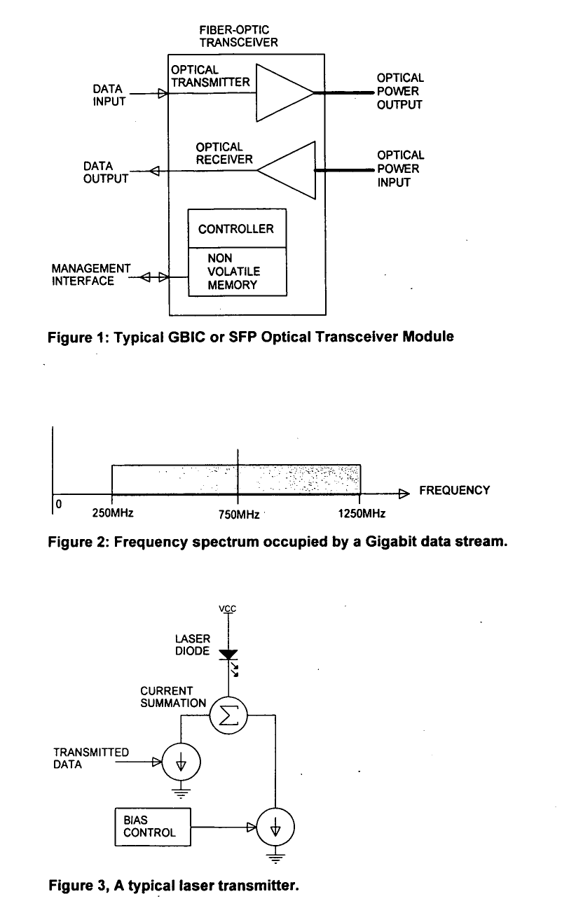

### DESCRIPTION OF THE INVENTION

In the following detailed description, reference is made to the accompanying drawings, which form a part of the application, and in which are shown by way of illustration, specific embodiments by and through which the invention may be practiced. The embodiments shown in the drawings include only a few examples of the many embodiments disclosed herein, and are provided in sufficient detail to enable those of ordinary skill in the art, to make and use the invention. As one of skill in the art can appreciate, many structural, logical or procedural changes may be made to the specific embodiments disclosed herein without departing from the spirit and scope of the present invention.

The invention provides a means to pass management information between the optical transceivers on either end of a fiber optic link. This information is passed in a low-frequency and low power, manner that does not interfere with the high-frequency data signal, and is completely independent of both the frequency and the communications protocol used on the high-frequency data link.

The basic mechanism involves a modified fiber-optic transceiver, shown in FIG. 13, comprised of a modified optical transmitter (50), a modified optical receiver (51), a non-volatile memory (55), and a controller (54).

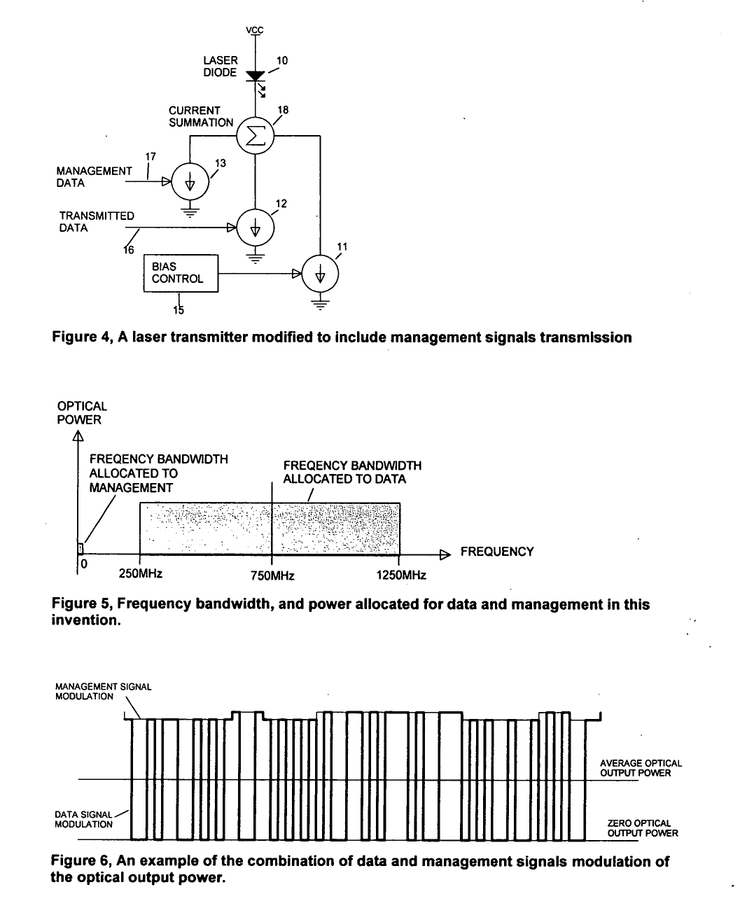

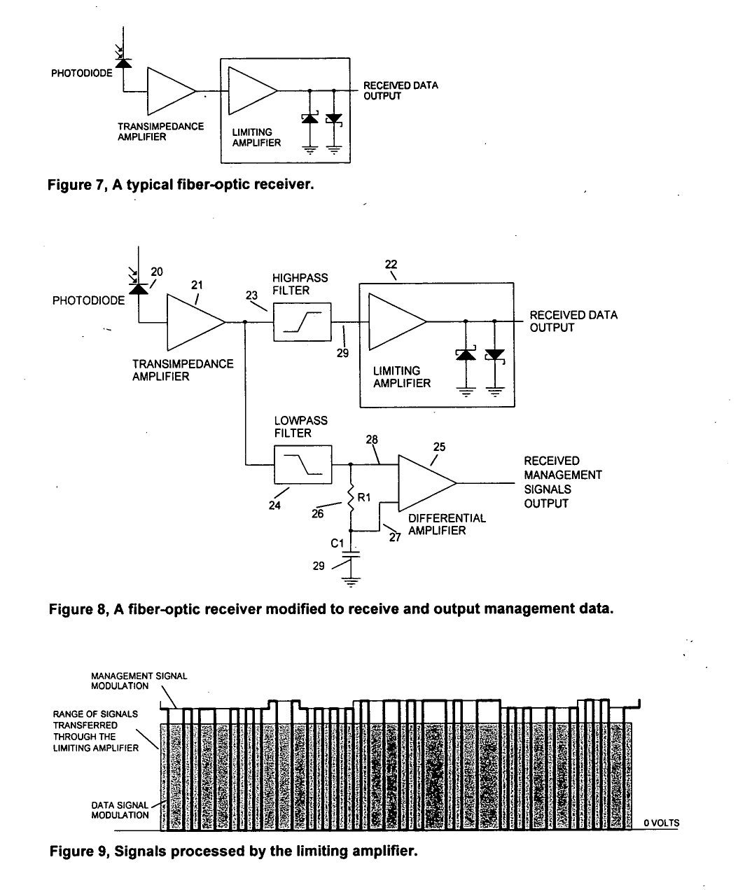

The fiber-optic transmitter (50), whose embodiment is shown in FIG. 4, comprises of a laser diode (10), a management data modulation current source (13), a high-speed data modulation current source (12), a bias current source (11), and a bias control circuit (15). The bias current generated by the bias current source (11) is controlled by the bias current control circuit (15), and sets the minimum optical output power. The bias current control circuit (15) receive inputs about the environmental conditions of the laser diode (10), and adjusts the bias current to maintain the same minimum of optical output power under all conditions. High-frequency data (16) to be transmitted over the fiber-optic link, controls the currents generated by the data modulation current source (12). When the high-frequency data (16) is at a logic state of “0” the data modulation current source (12) generates no current, and when the data (16) is at a logic state of “1”, the data modulation current source (12) generates the maximum data modulation current, causing the laser diode (10) to generate the maximum optical output power. The data modulation current is summed together with the bias current on the summation node (18). The management data modulation current source (13) generates in response to management data (17) an additional management modulation current. When the management data (17) is in a logic state of “0”, the management modulation current source (13) generates no current, and when the management data (17) is in a logic state of “1”, the current source (13) generates a current significantly smaller than the high-frequency data (16) modulation current. The management modulation current is also summed on the summation node (18) with the bias and the high-frequency data modulation current, causing a small increase in the optical output power whenever the management data input (17) is in the logic state of “1”.

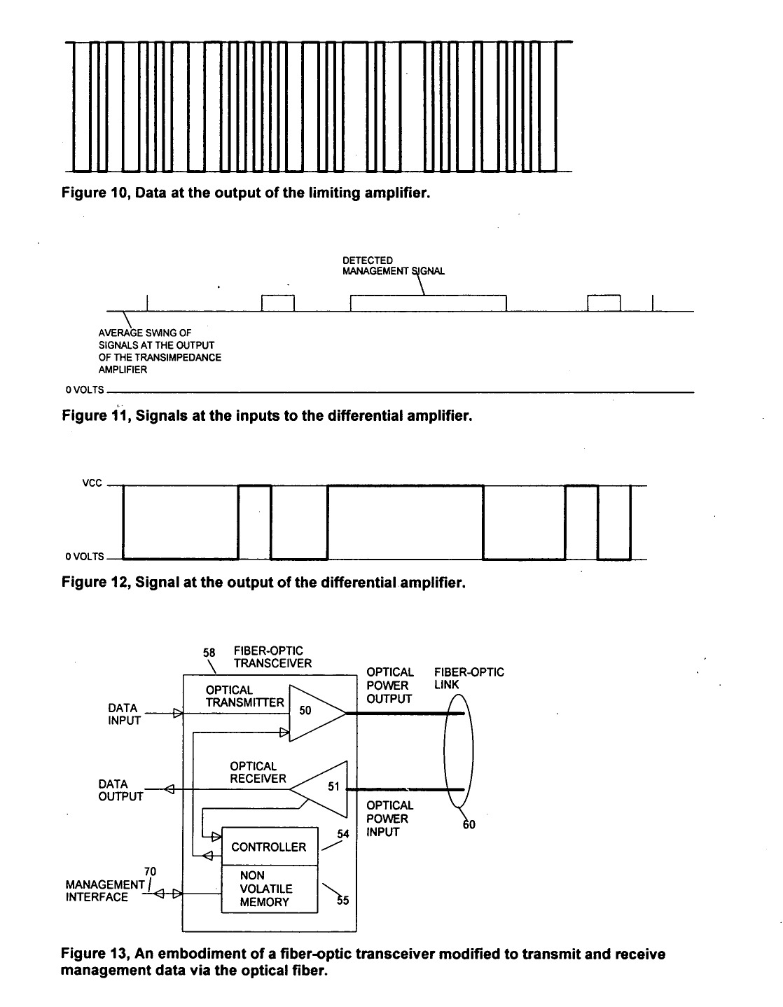

An embodiment of a fiber-optic receiver modified to receive management data via its optical interface is shown in FIG. 8. The receiver is comprised of a photodiode (20), a transimpedance amplifier (21), a highpass filter (23), a limiting amplifier (22), a lowpass filter (24), a second lowpass filter comprised of the resistor R1 (26) and the capacitor C1 (29), and a differential amplifier (25). Received optical power generates a current flow through the photodiode (20), which is amplified, by the transimpedance amplifier (21), and converted to an output voltage directly proportional to the magnitude of the optical power. The electrical output signal from the amplifier (21), is applied to two filters, a highpass filter (23), and a lowpass filter (24). The cutoff frequency of the highpass filter (23) is two orders of magnitude higher than the cutoff frequency of the lowpass filter (24). As a result, only the high-frequency signals pass through the hughpass filter, and any low frequency signals are rejected. The output of the highpass filter (29) connects to a limiting amplifier (22), which amplifies and limits small signals at its input, but rejects and discards any variation on the magnitude of the signal at its input (29), caused by the management data modulation, as shown in FIG. 9. The resulting output from the limiting amplifier (22) is the recovered high-frequency data, as shown in FIG. 10. The lowpass filter (24) passes only signal of a very low frequency, including DC. As a result, the output (28) of the lowpass filter (24) is a DC voltage, equal to one half the peak to peak amplitude of the signal at the output from the transimpedance amplifier (21), with a small signal, generated by the management data modulation, riding over it as show in FIG. 11. The second lowpass filter comprised of R1 (26), and C1 (29), has a time constant τ=R1C1, wherein τ is selected such that τ>>tₘₐₓ, and wherein tₘₐₓ is the duration of the longest run of consecutive bits of the same sign. As a result, the output (27) of the second lowpass filter (26, 29), is just the DC voltage at the output of the first lowpass filter (24). The differential amplifier (25) receives the DC voltage (27) of one of its input pins, and the DC voltage combined with the small modulation signal (28) on its other input pin. The differential amplifier (25) amplifies the difference between the DC voltage (27), and the DC voltage with the small modulation signal (28), resulting in an output signal, which is the recovered management data, as shown in FIG. 12.

An alternative method of extracting the low frequency management data is shown in FIG. 15. Received optical power generates a current flow (108) through the photodiode (100), which is amplified, by the transimpedance amplifier (102), and converted to an output voltage directly proportional to the magnitude of the optical power. The electrical output signal from the transimpedance amplifier is further amplified by the limiting amplifier (104), which attenuates all the low frequency signal components, and outputs the high frequency signal (106). The photodiode current (108) is directly proportional to the average optical power received by the photodiode (100). With normal high frequency data signals the average power is constant, and thus the photodiode current (108) is practically a DC current. The capacitor (110) helps to remove high frequency components from the photodiode current (108).

When low frequency management signals are added (modulated) on top of the high frequency, the average power changes slightly, and so does the photodiode current (108). A current mirror (112) generates an output current Iₜ (114), which is Iₜ=I_{pd}×K. The current Iₜ is applied to the low impedance winding of the transformer (116). For the management data to be a low frequency signal, a transformer used for audio signals may be used. The transformer (116) has two windings, a primary, typically the high impedance side, and a secondary. The ratio in the number of turns between the primary and the secondary windings is n, wherein

$${T}_{2} = \frac{{T}_{1}}{n} ,$$

and wherein T₁ is the number of wire turns in the primary winding, and T₂ is the number of turns in the secondary. For DC signals the resistance of either winding is very low, and close to zero. DC signals do not couple through the transformer, but AC signals within the bandwidth of the transformer couple through with the currents and voltages ratio as follows:

$${I}_{2} = {I}_{l} \times n , {V}_{2} = \frac{{V}_{l}}{n} .$$

The impedance reflected through the transformer is therefore

$${Z}_{2} = \frac{{Z}_{1}}{{n}^{2}} .$$

In audio transformers winding ratios of n=100 is not uncommon. For such a transformer, an impedance of 100 KΩ in the primary is reflected as 10 Ω in the secondary. In the circuit of FIG. 15, the current Iₜ (114) generated by the current mirror (112) is applied to the secondary winding of the transformer (116), and the voltage developing on the secondary winding is

$${V}_{2} = \frac{{Z}_{1}}{{n}^{2}} \times {I}_{t} , \text{wherein} {Z}_{l} = \frac{R \times \frac{1}{j ω C}}{R + \frac{1}{j ω C}} .$$

At low frequencies the component

$$\frac{1}{j ω C}$$

is negligible, and thus Z₁=R. The voltage coupled to the primary is v₁=v₂×n, and for n=100, V₁=100V₂. The resistor R (118) is very large, and the AC voltage coupled through the transformer (116) is developing on this resistor is applied to the comparator (122). The comparator (122) senses the AC signals developing on the resistor (118), and converts those signals to logic levels output signals.

The circuit shown in FIG. 15, is very efficient in rejecting all the high frequency components of the signals received, and adequately amplifying and extracting the low frequency management signals only. The capacitor (110) is the first in line to attenuate high frequency signals, then the transformer (116) transfers only audio signals, and greatly attenuate all the signals outside of its bandwidth of operation, and finally the resistor (118) and the capacitor (120) form a lowpass filter having a bandwidth of

$${F}_{BW} = \frac{1}{2 π RC} .$$

The controller (54) generates a data payload and transmits it through the optical transmitter by adding a small amount of low frequency current directly to the laser transmitter (50), thus amplitude-modulating the optical power. The controller (54) makes use of standard data communications techniques (applied at low frequency) to pass a self-synchronizing data stream to the fiber-optic transmitter (50). The receiver (51), extracts low frequency management data, and passes it to the controller (54). The controller (54) disseminate the received data and uses it in accordance with its preprogrammed instructions. The controller (54) is directly interfaced with the non-volatile memory (55), on which it stores operational parameters, and from which it retrieves such parameters. Both the controller (54) and the non-volatile memory (55), are interfaced via serial electrical communication link (70), to the management functions and circuits outside the transceiver (58), using a standard specified serial communications interface.

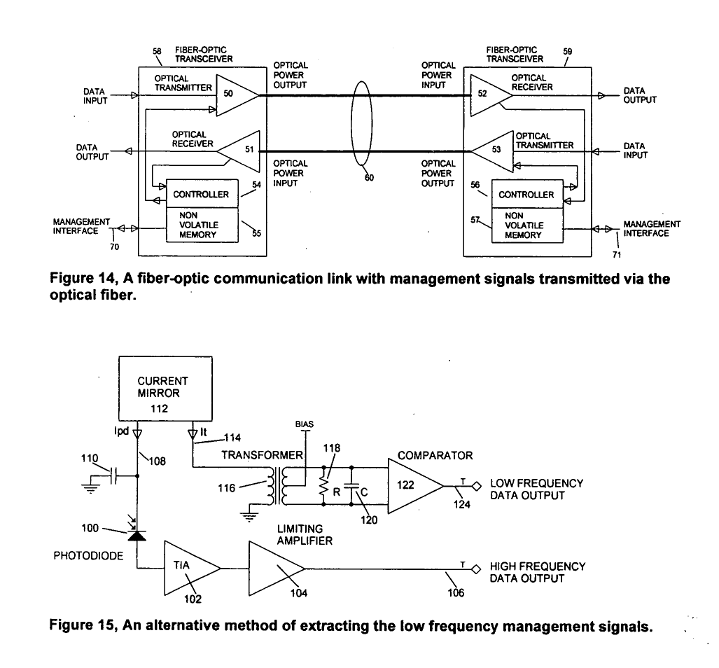

In FIG. 14, an embodiment of a fiber-optic communication link, capable of passing management data via the optical interfaces, is shown. The link is comprised of a fiber-optic transceiver (58), a fiber-optic cable (60), and a second fiber-optic transceiver (59). Both transceivers (58, and 59) are identical in their function. Each transceiver can communicate with the transceiver on the other end of the fiber-optic cable, by passing management messages between the transceivers. In addition, each fiber-optic transceiver (58, 59) can communicate with management functions outside the transceiver via an electrical serial interface link (70, 71).

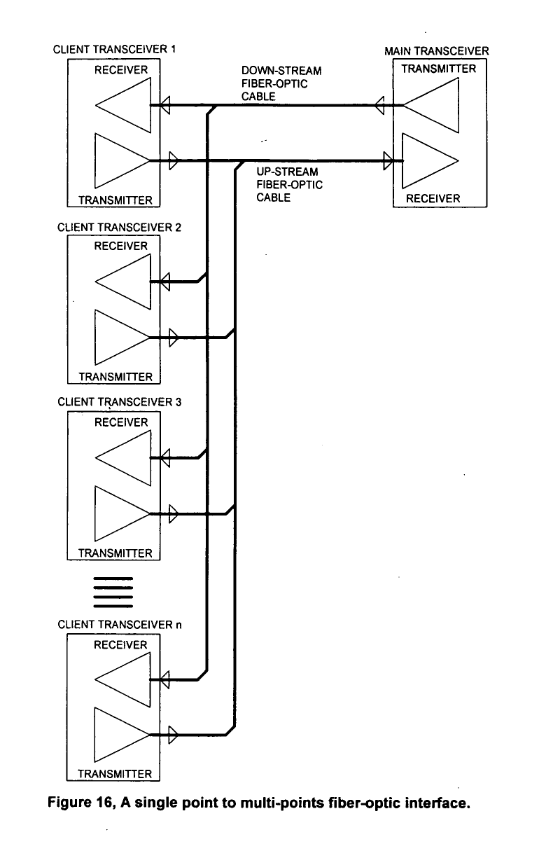

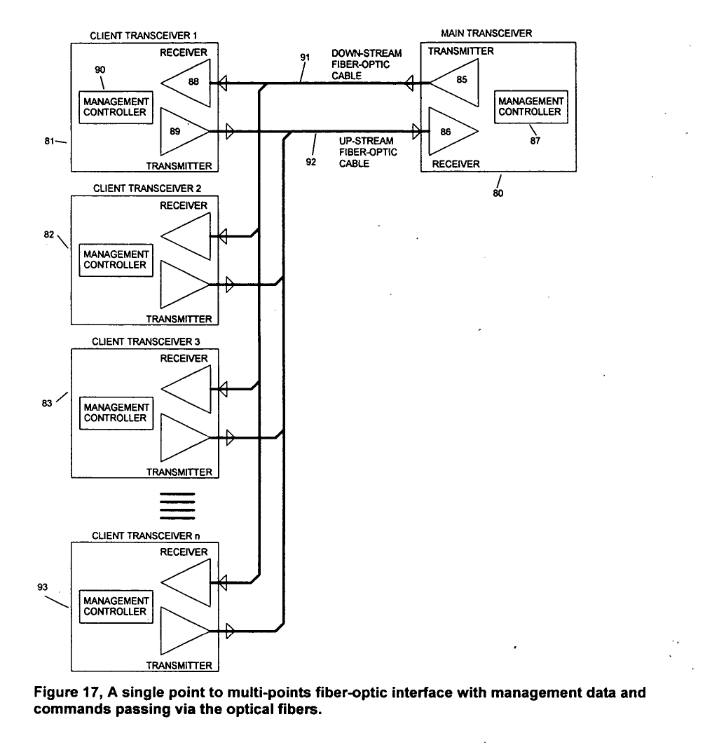

FIG. 16, shows an embodiment of another type of fiber-optic interface capable of passing management messages via the optical fiber, simultaneously with the transmission of high-frequency data, and over the same optical wavelength. In this type of interface also known in the art as “single point to multiple points” interface, A single main transceiver (80) is used to interface by means of optical fibers (91, 92) with “n” client transceivers (81,82, 83, 93). Each transceiver is comprised of a fiber-optic transmitter (85, 89), a fiber optic receiver (86, 88), and a management controller (87, 90). The transmitters (85, 89) are each modified to allow the superposition of management messages on top of the high frequency data transmission. The receivers (86, 88) are each modified to allow the extraction of management messages which have been received super-positioned on top of high-frequency data transmissions, and the separation of the low-frequency management data from the high-frequency data. The management controllers (87, 90) are designed to generate management messages, and to instruct the transmitter (85, 89) to transmit the management messages superimposed over transmitted high-frequency data. The controllers (87, 90) are also designed to receive management messages from the receivers (86, 88), decipher them and respond in accordance with instructions sent by management messages.

The transmitter (85) of the main transceiver (80), sends data transmissions via the “down stream” fiber-optic cable (91), to all the receivers simultaneously, with management messages superimposed over the transmitted data. In the transceivers (81, 82, 83, 93) the transmitted optical power is received, converted to electrical signals, and separated to high-frequency data, and low-frequency management data, which is transferred to the management controllers in the corresponding transceivers. The management messages instruct the controller as to certain operations, including instructions to start a data transmission, and the length of time allowed for that transmission.

For an “up stream” transmission, a transceiver (81, 82, 83, 93) starts data transmission when instructed by the main transceiver (80). The optical outputs, of all the transmitters, are directed into the single “up stream” fiber-optic cable (92), connected to the receiver (86) of the main transceiver (80). Since only one transmitter is allowed to transmit at any time, there is no contention between transmissions from different transceivers. While a transceiver is allowed to transmit, it transmits the high-frequency data, with the management data superimposed over it. The receiver (86) of the main transceiver (80) receives the optical power, converts it into electrical signals, and separates the high-frequency data from the low-frequency management data.

While the invention has been described in detail in connection with certain preferred embodiments known at the time, it should be readily understood that the methods and devices of the invention are not limited to the disclosed exemplary embodiments. Rather, the present devices, apparatus and methods can be modified to incorporate any number of variations, alterations, substitutions or equivalent arrangements not heretofore specifically described, but which are commensurate with the spirit and scope of the invention.

1. A fiber-optic communication link comprising:
A first fiber-optic transceiver;
A bi-directional fiber-optic cable; and
A second fiber-optic transceiver;
Wherein management data can pass alongside and simultaneously to high speed data communication via the fiber-optic cable in both directions between the first fiber-optic transceiver, and the second fiber-optic transceiver, and between the second fiber-optic transceiver, and the first fiber-optic transceiver.

2. A fiber-optic transceiver as in claim 1, comprising:
An optical transmitter;
An optical receiver;
A controller; and
A non-volatile memory;
wherein management data can be passed both via a fiber-optic serial interface, and an electrical serial interface.

3. An optical transmitter as in claim 2, comprising:
A laser diode;
A bias current source;
A bias current control circuit;
A high-frequency data modulation current source; and
A low-frequency management data modulation current source, generating a current significantly smaller than the high-frequency data modulation current source;
Wherein the current of all three current sources is summed together to drive a laser diode, and generate an optical power output combining the high-frequency data and the low-frequency management data signals.

4. An optical receiver as in claim 2, comprising:
A photodiode;
A transimpedance amplifier;
A highpass filter having a cutoff frequency significantly higher than the cutoff frequency of the first lowpass filter;
A limiting amplifier;
A first lowpass filter having a cutoff frequency significantly lower than the cutoff frequency of the highpass filter; and
A second lowpass filter having a cutoff frequency significantly lower than the cutoff frequency of the first lowpass filter;
wherein signals passing through the highpass filter are used to recover the high-frequency data, and wherein signals passing the first lowpass filter are used to recover the low-frequency management data.

5. A controller as in claim 2, wherein the controller:
Interfaces directly to a non-volatile memory;
Interfaces with devices outside the fiber-optic transceiver module via a dedicated electrical bidirectional communication link;
Interfaces with the management data modulation input of the laser transmitter inside the fiber-optic transceiver module;
And interfaces with the low-frequency data output of the fiber-optic receiver inside the fiber-optic transceiver module.

6. A controller as in claim 5, wherein the controller generates data payloads to be transmitted over the fiber-optic to a controller on the alternate end of a fiber-optic communication link.

7. A controller as in claim 5, wherein the controller receives data payloads generated on the alternate end of a fiber-optic communication link, and transmitted by means of optical power over the fiber-optic link.

8. A controller as in claim 5, wherein the controller upon receiving of a data payload responds by:
Monitoring an operation or condition within a fiber-optic transceiver;
Measuring operational and environmental parameters within a fiber-optic transceiver;
Adjusting, varying, and modification of operations and conditions within a fiber-optic transceiver;
Applying data loop-back;
And storing data in a non-volatile memory, or retrieve data from a non-volatile memory within the fiber-optic transceiver module.

9. A fiber-optic communication link comprising:
A fiber-optic transmitter;
A fiber-optic cable;
A fiber-optic receiver;
Wherein management data can pass alongside and simultaneously to high speed data communication via the fiber-optic cable between the fiber-optic transmitter, and the fiber-optic receiver.

10. A fiber-optic transmitter as in claim 9, comprising:
A laser diode;
A bias current source;
A bias current control circuit;
A high-frequency data modulation current source;
A low-frequency management data modulation current source, generating a current significantly smaller than the high-frequency data modulation current source;
A controller; and
A non-volatile memory;
Wherein the currents of all three current sources are summed together to drive a laser diode, and generate an optical power output combining the high-frequency data and the low-frequency management data signals, and wherein the modulated optical power transmitted over a fiber-optic cable can pass both high-frequency data and low frequency management data to the alternate end of the fiber-optic link.

11. A fiber-optic transmitter as in claim 10, wherein management data can be passed both via a fiber-optic serial interface, and an electrical serial interface.

12. An optical receiver as in claim 9, comprising:
A photodiode;
A transimpedance amplifier;
A highpass filter having a cutoff frequency significantly higher than the cutoff frequency of the first lowpass filter;
A limiting amplifier;
A first lowpass filter having a cutoff frequency significantly lower than the cutoff frequency of the highpass filter;
A second lowpass filter having a cutoff frequency significantly lower than the cutoff frequency of the first lowpass filter;
A controller; and
A non-volatile memory;
Wherein the receiver can receive modulated optical power containing both high-speed data and low speed management data, and wherein signals passing through the highpass filter are used to recover the high-frequency data, and wherein signals passing the first lowpass filter are used to recover the low-frequency management data.

13. A fiber-optic receiver as in claim 12, wherein management data can be passed both via a fiber-optic serial interface, and an electrical serial interface.

14. A controller as in claims 10, wherein the controller:
Interfaces directly to a non-volatile memory;
Interfaces with devices outside the fiber-optic transmitter module via a dedicated electrical bidirectional communication link;
Interfaces with the management data modulation input of the laser transmitter inside the fiber-optic transmitter module.

15. A controller as in claims 12, wherein the controller:
Interfaces directly to a non-volatile memory;
Interfaces with devices outside the fiber-optic receiver module via a dedicated electrical bidirectional communication link;
And interfaces with the low-frequency data output of the fiber-optic receiver inside the fiber-optic receiver module.

16. A controller as in claim 14, wherein the controller generates data payloads to be transmitted over the fiber-optic to a controller on the alternate end of a fiber-optic communication link.

17. A controller as in claim 15, wherein the controller receives data payloads generated on the alternate end of a fiber-optic communication link, and transmitted by means of optical power over the fiber-optic link.

18. A controller as in claim 14, wherein the controller upon receiving of a data payload responds by:
Monitoring an operation or condition within a fiber-optic transmitter;
Measuring operational and environmental parameters within a fiber-optic transmitter;
Adjusting, varying, and modification of operations and conditions within a fiber-optic transmitter;
And storing data in a non-volatile memory, or retrieve data from a non-volatile memory within the fiber-optic transmitter module.

19. A controller as in claim 15, wherein the controller upon receiving of a data payload responds by:
Monitoring an operation or condition within a fiber-optic receiver;
Measuring operational and environmental parameters within a fiber-optic receiver;
Adjusting, varying, and modification of operations and conditions within a fiber-optic receiver;
And storing data in a non-volatile memory, or retrieve data from a non-volatile memory within the fiber-optic receiver module.

20. A non-volatile memory as in claims 2, 10, and 12, wherein the non-volatile memory stores:
Permanent identification information;
Permanent operational parameters;
Temporary values and conditions of varying parameters;
Environmental parameters;
And management information;
Wherein the memory interfaces directly with a controller, and wherein the controller can access the memory to store or retrieve data, and further wherein the memory can interface with devices extraneous to the module in which the memory is installed via a dedicated bidirectional electrical communication link.

21. A single point to multiple points fiber-optic communication interface comprising:
A main fiber-optic transceiver;
A down-stream fiber-optic cable;
An up-stream fiber-optic cable;
And a plurality of client fiber-optic transceivers;
Wherein management data passes from the main transceiver to any client transceiver via the down-stream fiber optic cable, and from any client transceiver to the main transceiver, via the up-stream fiber-optic cable.

22. A main fiber-optic transceiver as in claim 21, comprising:
An optical transmitter;
An optical receiver;
A controller; and
A non-volatile memory;
wherein management data can be passed both via a fiber-optic serial interface, and an electrical serial interface.

23. An optical transmitter as in claim 22, comprising of:
A laser diode;
A bias current source;
A bias current control circuit;
A high-frequency data modulation current source; and
A low-frequency management data modulation current source, generating a current significantly smaller than the high-frequency data modulation current source;
Wherein the current of all three current sources is summed together to drive a laser diode, and generate an optical power output combining the high-frequency data and the low-frequency management data signals.

24. An optical receiver as in claim 22, comprising:
A photodiode;
A transimpedance amplifier;
A highpass filter having a cutoff frequency significantly higher than the cutoff frequency of the first lowpass filter;
A limiting amplifier;
A first lowpass filter having a cutoff frequency significantly lower than the cutoff frequency of the highpass filter; and
A second lowpass filter having a cutoff frequency significantly lower than the cutoff frequency of the first lowpass filter;
Wherein signals passing through the highpass filter are used to recover the high-frequency data, and wherein signals passing the first lowpass filter are used to recover the low-frequency management data.
